(19) United States
(12) Patent Application Publication
(10) Pub. No.: US 2006/0129072 A1
(43) Pub. Date: Jun. 15, 2006

(54) Far infra-red ray and anion emitting thermal rotary massage device for decreasing the fat in the abdominal region of a human body

(76) Inventor: Thomas JB Shin, Los Angeles, CA (US)

Correspondence Address: Eugene Oak, Ph.D., J.D.;Patent Attorney, 610 S. Van Ness Ave., Los Angeles, CA, 90005, US

(21) Appl. No.: 11/008,624

(22) Filed: Dec. 10, 2004

(51) Int. Cl. A61H 1/00; A61H 7/00

(52) U.S. Cl. 601/18; 601/15; 601/87; 601/113

(57) ABSTRACT

A rotary massage apparatus, which thermally massage muscles of human body while emitting anions and far-infrared rays by heating an electric heating element embedded inside of a ceramic layer that forms massage ball. The rotary heating massage apparatus is comprised of 1) a case, 2) an electric motor, 3) a worm (a gear looks like worm), connected to the electric motor, 4) a pair of worm wheels that are engaged to the worm, 5) two rotary shafts each of them is rotatably connected onto one worm wheel, 6) two rotary connection parts for applying electric power, each of them connects four connection wires of two heaters between the bottom surface of the rotary plate and the top surface of the case, 7) two rotary plates, having mounting holes thereon, and each of them is connected to one of the rotary shafts, 8) four massage balls mounted in the mounting holes with a predetermined height; and 9) four heating devices each one of them is comprised of a) a heating part having a heating element connected to a connection wire and molded inside the massage ball, and b) a rotary connection part for applying electricity through the connection wire of the heating part between the bottom surface of the rotary plate and the top surface of the case. The relative position of the massage balls are designed to stimulate the nerve part on the abdominal region of a human body.

### FIELD OF THE INVENTION

The present invention relates to a rotary massage apparatus, which can thermally massage muscles of human body by heating massage balls during rotatably massaging the human body.

### BACKGROUND OF THE INVENTION

Most of rotary massage apparatus of prior art do not have heating elements that emits far infra-red ray or anions, which are known as effective for chronic diseases, such as constipation or digestive disorder. Moreover, the relative position of the massage balls are designed without a significant consideration of the special nerve parts on the abdominal portion of a human body that are known to essential part for curing/preventing chronic diseases, such as constipation or digestive disorder. As a result, the rotary massage apparatus of the prior art are not effective for promotioning the circulation of blood, relaxing muscles, and reducing fats in the abdominal region of a human body.

### SUMMARY OF THE INVENTION

It is the primary purpose of the current application to provide a rotary massage apparatus, which thermally massage muscles of human body while emitting anions and far-infrared rays. By combining the effects of the anion and far infra-red ion rays with the specially designed massage balls' position, the massage apparatus of the current application reduces the fat portion in the abdominal portion of a user up to 18 cm³ . The secondary purpose of the current application is to simplify the rotating connector for supplying the electricity to the heating element embedded in the massage balls. The rotary heating massage apparatus is comprised of 1) a case, 2) an electric motor, 3) a worm (a gear looks like worm), connected to the electric motor, 4) a pair of worm wheels that are engaged to the worm, 5) two rotary shafts each of them is rotatably connected onto one worm wheel, 6) two rotary connection parts for applying electric power, each of them connects four connection wires of two heaters between the bottom surface of the rotary plate and the top surface of the case, 7) two rotary plates, having mounting holes thereon, and each of them is connected to one of the rotary shafts, 8) four massage balls mounted in the mounting holes with a predetermined height; and 9) four heating devices each one of them is comprised of a) a heating part having a heating element connected to a connection wire and molded inside the massage ball, and b) a rotary connection part for applying electricity through the connection wire of the heating part between the bottom surface of the rotary plate and the top surface of the case. The relative position of the massage balls are designed to stimulate the nerve part on the abdominal region of a human body.

### BRIEF DESCRIPTION OF THE DRAWINGS

FIG. 1 is an exploded perspective view of the first embodiment of the rotary massage apparatus of the current application.

FIG. 2 is a perspective view showing an assembled state of FIG. 1.

FIG. 3 is a vertically sectional view of FIG. 2.

FIG. 4 is a cross sectional view of the heating part of the massage apparatus having a lamp inside according to the second embodiment of the current application.

FIG. 5 is an exploded perspective view showing the third embodiment of the current application.

FIG. 6 is a vertically sectional view showing an assembled state of FIG. 5;

FIG. 7 is a partial view of a connection terminal according to the third embodiment of the current application.

FIG. 8 is a chromatography showing the emission of far infrared ray from the massage apparatus of the current application.

### DETAILED DESCRIPTION OF THE PREFERRED EMBODIMENT

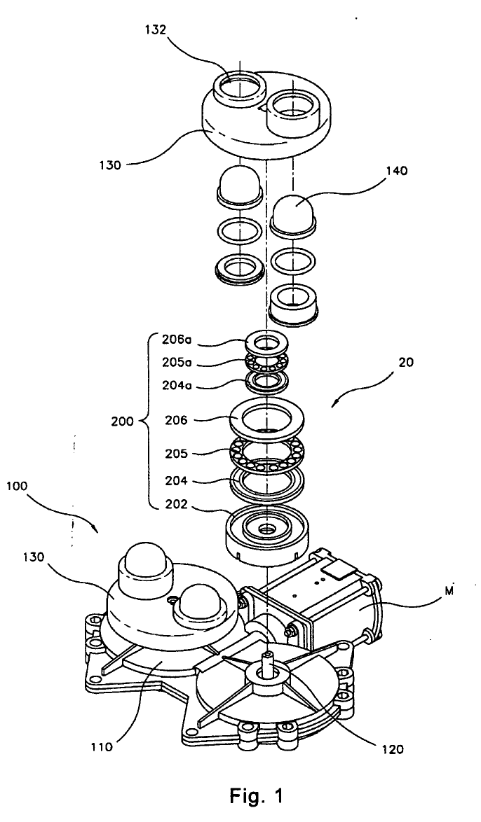

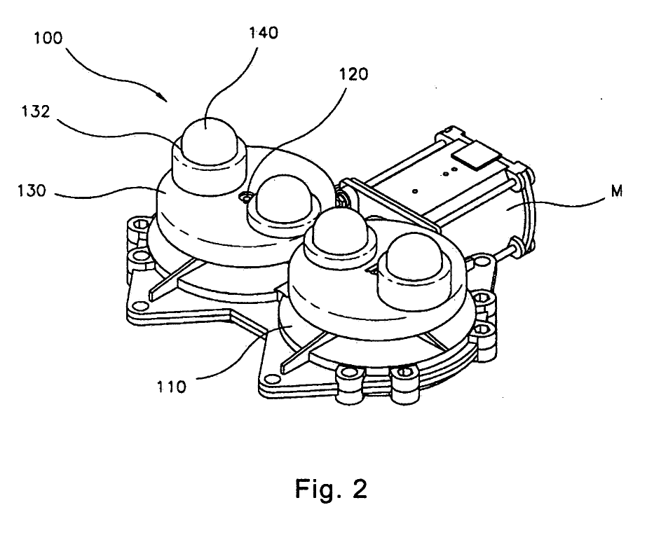

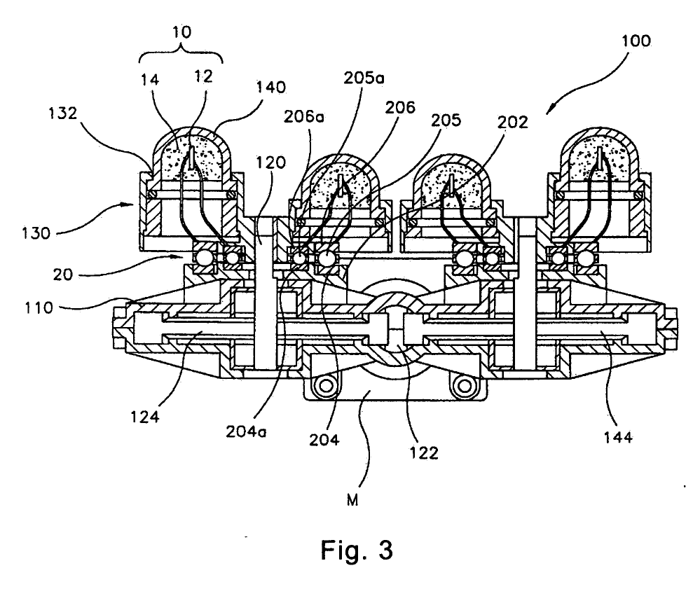

FIG. 1 is an exploded perspective view of the first embodiment of the rotary massage apparatus (100) of the current application, FIG. 2 is a partially perspective view showing an assembled state of FIG. 1, and FIG. 3 is a vertically sectional view of FIG. 2.

As shown in the drawings, the rotary massage apparatus (100), emitting far-infrared ray and anions, includes: a case (110); a rotary shaft (120) rotatably connected onto a worm (122) and a pair of worm wheels (124) engaged to the worm (122). The worm (122) and worm wheels (124) are mounted inside a case (110). A motor M rotates the worm (122) in a vertical plane and the worm (122) rotates the worm wheels (124) on a horizontal plane; a rotary shaft (120) is connected to a worm wheel (124) at the center thereof. A rotary plate (130) with two mounting holes (132) is connected to the rotary shaft (120). Pluralities of massage balls (140) are engaged to the mounting holes (132) with a predetermined height.

The rotary massage apparatus according to the first embodiment of the current application further includes: a heating part (10) having a heater (12), made of nickel/chrome wire, connected with a connection wire for applying electric current. The heater (12) is molded with filling material (14), such as silicon and then the silicon is hardened by heating above 400° C. A rotary connection part (20) for applying electric power by connecting the connection wire of the heater between the bottom surface of the rotary plate (130) and the top surface of the case (110).

Preferably, the rotary connection part (20) includes: a seating member (202) that fit on ribs formed on the upper surface of the case (110) and does not move; and a bearing connection member (200), which has; 1) fixed rings (204) and (204a) that are mounted on the upper surface of the seating member (202), and are connected with a power supply wire at the inner side and the outer side thereof, 2) rotating rings (206) and (206a) that are supported by the bottom surface of the rotary plate (130) and rotatably connected with the power supply wire of the heater, and 3) rolling ball bodies (205) and (205a) having a plurality of rolling balls between the fixed rings (204) and (204a) and the rotating rings (206) and (206a).

The rotary plate (130) connected with the rotary shaft (120) is rotated while the worm (122) and the worm wheels (124) are rotated by driving force of the motor (M), so that the massage balls (140) mounted in the mounting holes of the rotary plate (130) massage the user's body. Meanwhile, the massage balls (140) are heated by the electricity supplied to the heater (12) inside thereof.

Because the massage balls thermally massage the user's body in a heated condition during rotation, the massage apparatus of the present invention can more effectively relax muscles of the user's body and promote circulation of blood by massaging certain regions of the user's body in a warm condition.

Since the massage balls (140) have different height from the plate (130), the balls can stimulate the special nerve part evenly at the same time such as ‘Jung Wan; known as nerve part sensitive to stomach’, ‘Ha Wan; known as nerve part sensitive to duodenum’, ‘Shin Kwol (the navel); known as nerve part sensitive to digestive upset’, ‘Ki Hae; known as nerve part sensitive to kidney’, and ‘Kwan Won; known as nerve part sensitive to uterus and small intestine’, which are positioned at the different depth from the curvatured surface of the abdominal portion.

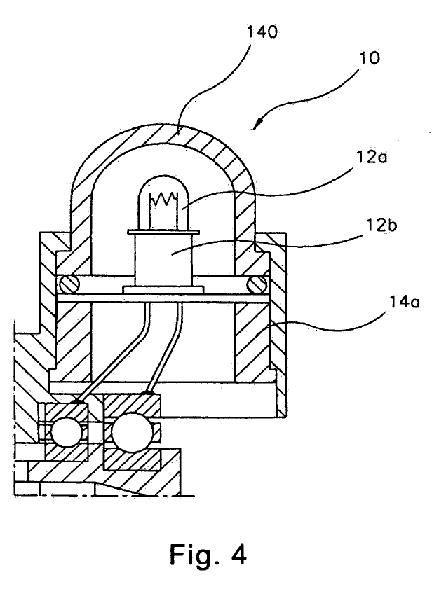

Another embodiment of the current application is embedding a heating lamp (12a) in the heating part (10). FIG. 4 is a cross sectional view of the heating part (10) of the massage apparatus having a heating lamp (12a) inside according to another embodiment of the present invention. A socket (12b) of the heating lamp (12a), a helium lamp, is mounted by a fixing portion (14a) for fixing the massage balls (140) on the rotary plate (130). Lead wires of the socket (12b) are respectively connected to the rotating rings of the rotary connection part in order to supply electric power smoothly. The heating part can have an ultrasonic generator, an anion generator, or others therein for generating things useful for human body by applying electric current.

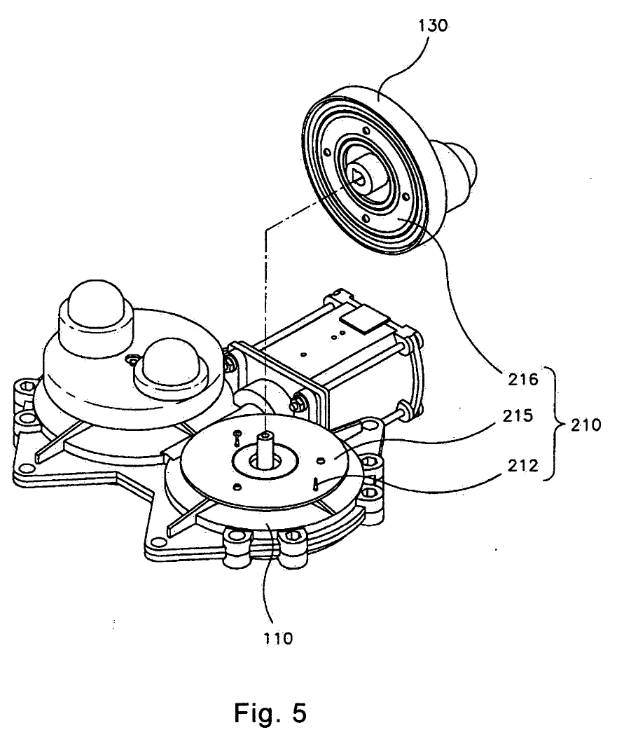

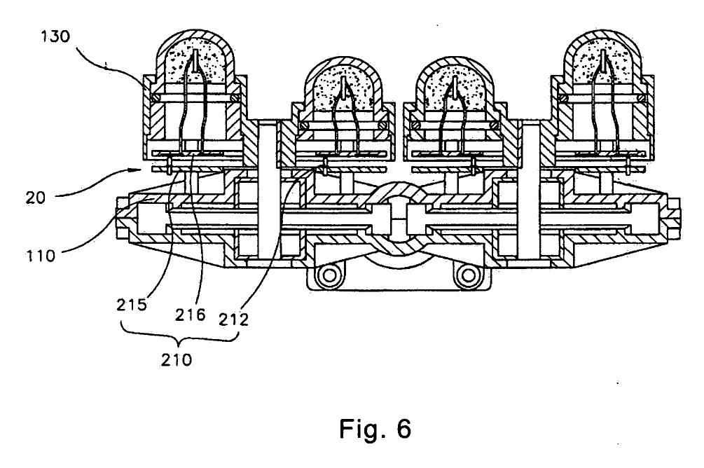

FIG. 5 is an exploded perspective view according to third embodiment of the present invention, and FIG. 6 is a vertically sectional view of FIG. 5. The structure of the rotary connection part (20a) for supplying power source to the heating part of the massage balls is different from that (20) of the the first embodiment of the invention FIG. 3. The rotary connection part (20a) includes a printed circuit board connecting member (210). The printed circuit board connecting member (210) includes: 1) a fixed printed circuit board (215) that is fixed on the top surface of the case (110) and is connected with the power supply wires at the inner and outer sides thereof and has a pattern where connection terminals (212) are connected, such as well-known pin bearings elastically mounted by a spring mounted therein, 2) a rotary printed circuit board (216) that is rotatably fixed on the bottom surface of the rotary plate (130), connected with the connection wire of the heater, and having a pattern for allowing the printed circuit board (216) to be connected with the connection terminals (212), such as the pin bearings.

The connection terminals (212) of the printed circuit board (215), fixed on the top surface of the case (110), are connected to the pattern of the rotary printed circuit board (216) that is fixed on the bottom surface of the rotary plate (130) to supply electricity to the heating part in the massage ball. The rotary connection part has more simple structure than the bearing connection member.

The massage balls (140) are made of plastic-molded ceramics, silicon for example, for emitting far infrared rays, which is known as to promote circulation of blood and metabolism by the far infrared rays useful for the human body.

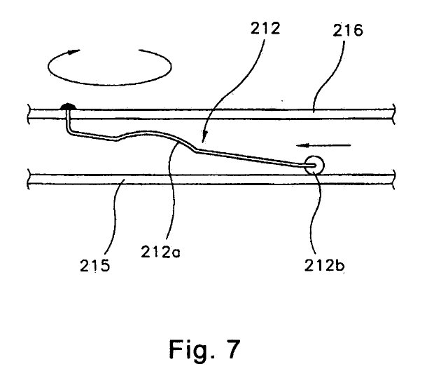

FIG. 7 is a partial view of a connection terminal according to another embodiment of the present invention. The connection terminal (212) located between the printed circuit boards (215) and (216) includes an elastic fragment (212a) having an end fixed to the pattern of the printed circuit board (216) and a rolling connection roll (212b) that is mounted at the other end of the elastic fragment (212a) and connected to the pattern of the printed circuit board (215). The printed circuit board (216) is coupled with the printed circuit board (215) by means of the elastic fragment and the rolling connection roll of the connection terminal during rotation so as to apply electric current smoothly. The third embodiment of the present invention provides a more simple structure.

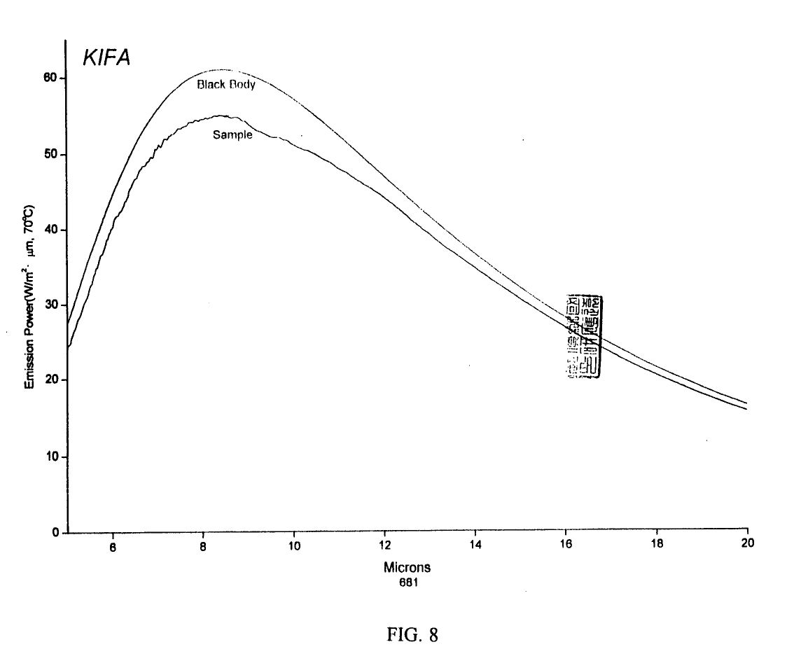

FIG. 8 is a chromatography showing the emission of far infrared ray from the massage apparatus of the current application. The curve marked as blue line shows the intensity of light waves at each wave length in micrometer. The curve shows a maximum intensity at the light wave length of shorter than 10 micrometer that is in the far infra-red wave length. That pattern can be observed from the light emitting curve of a black body. Concentration of anions measured by anion particle measuring instrument enduced by the Korea Far Infrared Association is 312 each/cm³.

Table 1. is a reading of fat reduce of a user of the massage apparatus of the current application. After one year use, 15 minutes per one nerve part a day for four nerve parts, the volume of fat in the user's body is measured by the NMR (Nuclear Magnetic Resonance) CT (Computerized Tomography). It shows decrease of 54 cm³ of fat from whole body and among them 18 cm cm³ of fat is decreased from the abdominal portion of the user.

TABLE 1
Readings of Body Fat Change from NMR CT photogram

| | Total Fat | Abdominal Fat | Fateness |
|---|---|---|---|
| | (cm³) | (cm³) | (%) |
| Before the Treatment | 325.57 | 74.50 | 22.88 |
| After the Treatment | 271.15 | 56.07 | 20.68 |

Since the massage balls are made of materials for emitting far infrared rays and anion, the massage apparatus of the current application reduces a body fat, especially for abdominal portion's fat, by promoting circulation of blood and metabolism through the massage function.

What is claimed is:

1. A rotary massage apparatus, which thermally massage muscles of human body while emitting anions at a concentration of 312 each/cm³ and far-infrared rays of 50 (Watts/m² μm, 70° C.) by heating an electric heating element embedded inside of a ceramic layer that forms massage ball is comprised of 1) a case, 2) an electric motor, 3) a worm (a gear looks like worm), connected to the electric motor, 4) a pair of worm wheels that are engaged to the worm, 5) two rotary shafts each of them is rotatably connected onto one worm wheel, 6) two rotary connection parts for applying electric power, each of them connects four connection wires of two heaters between the bottom surface of the rotary plate and the top surface of the case, 7) two rotary plates, having mounting holes thereon, and each of them is connected to one of the rotary shafts, 8) four massage balls mounted in the mounting holes with a predetermined height; and 9) four heating devices each one of them is comprised of a) a heating part having a heating element connected to a connection wire and molded inside the massage ball, and b) a rotary connection part for applying electricity through the connection wire of the heating part between the bottom surface of the rotary plate and the top surface of the case.

2. A heating device for rotary massage apparatus according to claim 1, wherein the rotary connection part includes: a seating member mounted on the upper surface of the case; and a bearing connection member having fixed rings mounted on the upper surface of the seating member and connected with a power supply wire at the inner side and the outer side thereof, rotating rings supported by the bottom surface of the rotary plate and rotatably connected with the connection wire of the heater, and rolling ball bodies located between the fixed rings and the rotating rings.

3. A heating device for rotary massage apparatus according to claim 1, wherein the rotary connection part includes a printed circuit board connecting member, the printed circuit board connecting member having: a fixed printed circuit board fixed on the top surface of the case, connected with the power supply wires at the inner and outer sides thereof, and having a pattern for connecting connection terminals; and a rotary printed circuit board rotatably fixed on the bottom surface of the rotary plate and connected with the connection wire of the heater, and having a pattern for allowing the printed circuit board to be connected with the connection terminals.

4. A heating device for rotary massage apparatus according to claim 1, wherein the heating element is a made of nickel/chrome wire.

5. A heating device for rotary massage apparatus according to claim 1, wherein the heating element is a helium lamp.

6. A heating device for rotary massage apparatus according to claim 1, wherein the massage balls are made of silicon and hardened over 400° C.

7. A heating device for rotary massage apparatus according to claim 1, wherein the massage balls have different heights from the rotating plate to stimulate nerve parts, which are positioned at the different depth from the curvatured surface of the abdominal portion of a user, evenly at the same time.
